(19) United States
(12) Patent Application Publication
(10) Pub. No.: US 2025/0110807 A1
(43) Pub. Date: Apr. 3, 2025

(54) Dynamic API Discovery System and Technique for Conversational Interfaces

(71) Applicant: Forum Systems, Inc., Needham, MA (US)

(72) Inventors: Mamoon Yunus, Newton, MA (US); Rizwan Mallal, Wellesley, MA (US)

(21) Appl. No.: 18/904,447

(22) Filed: Oct. 2, 2024

Related U.S. Application Data
(60) Provisional application No. 63/587,265, filed on Oct. 2, 2023.

(51) Int. Cl. G06F 9/54; G06F 40/30

(52) U.S. Cl. CPC G06F 9/54; G06F 40/30

(57) ABSTRACT

A dynamic API discovery system for conversational interfaces may comprise a processor and a memory with computer code instructions stored thereon. The memory is operatively coupled to the processor such that, when executed, the instructions cause the API discovery system to generate prompts configured to advise a user of permitted topics about which the user can have a conversation, receive a conversation request from the user, and select one or more relevant application programming interfaces (APIs) based on the conversation request provided by the user and an assigned guidance policy. The computer code instructions further cause the API discovery system to determine a semantic alignment score that measures relevance of the conversation with respect to a selected API and compare the semantic alignment score with a semantic alignment threshold and determine that the selected API is relevant to the conversation if the semantic alignment score exceeds the semantic alignment threshold.

### RELATED APPLICATION

This application claims the benefit of U.S. Provisional Application No. 63/587,265, filed on Oct. 2, 2023. The entire teachings of the above application are incorporated herein by reference.

### BACKGROUND

The effective management and utilization of information are paramount to the success of organizations across various sectors. Enterprises routinely grapple with vast collections of data, spanning structured and unstructured formats, often stored in diverse repositories. Extracting actionable insights from this trove of data has emerged as a crucial challenge, one that necessitates advanced techniques in knowledge management, natural language processing (NLP), Large Language Models (LLMs), and cutting-edge hardware acceleration such as graphics processing units (GPUs), accelerated processing units (APU)s, field programmable gate arrays (FPGAs) or application specific integrated circuits (ASICs).

A fundamental concept in knowledge management is the construction and utilization of knowledge graphs, taxonomies, and ontologies. These structures serve as repositories of domain-specific information, facilitating efficient organization, retrieval, and interpretation of data. Knowledge graphs represent entities, concepts, relationships, and attributes, interconnecting them in a coherent network. Taxonomies and ontologies, on the other hand, provide hierarchical frameworks for categorizing and structuring knowledge, allowing for systematic navigation through complex domains.

Advancements in NLP, LLMs and Generative Pre-trained Transformers (GPTs) have revolutionized how we interact with information and technology. These techniques enable machines to understand, process, and generate human language, opening doors to a wide range of applications, including chatbots, virtual assistants, and automated content analysis. Within this context, LLM and GPT technologies have played pivotal roles. These state-of-the-art LLMs, like GPT-3 and beyond, drive context-aware dialogues, facilitating knowledge extraction and personalized interactions.

In the realm of Conversational AI, policy-based conversation systems are crucial in controlling how enterprises interact with powerful and transformative technologies such as LLMs, application programming interfaces (APIs), Knowledge Graphs (KGs) and GPTs. Enterprises seek to ensure that conversations conducted by automated systems provide factual information, aligned with the organization's domain expertise, compliance standards, and user expectations. These policies dynamically steer conversations, pick the right responses such as APIs, KGs and LLMs, ensuring relevance, accuracy, and adherence to desired content boundaries.

### SUMMARY

The disclosed technique builds upon the foundations of taxonomy, ontology and knowledge graphs, application programming interfaces (APIs) and Large Language Models (LLMs) derived from target enterprise content to enable a knowledge-driven conversation system. Innovative techniques for determining which APIs are relevant based on semantic or knowledge graph analysis are deployed in a variety of form factors that optimize information access through conversation interfaces with greater accuracy, reduced latency and increased security for enterprises deploying Large Language Models (LLMs) and Generative AI technologies (e.g., Generative Pre-trained Transformers or GPT) for enhancing efficiency and accelerating business functions within their organizations.

The system may have multiple form factors, and may be deployed as dedicated hardware, a virtual machine, or software within an enterprise in such a way that the user (typically an employee within an organization) interacts with the system for conversations with chat engines and not with the chat engines directly. Depending on the latency and performance requirements, an organization may choose either hardware form factor with guidance processing accelerated via resource pinning, utilizing accelerators for guidance policies or may consider using standard virtual machine or software deployments for lower performance requirements. Based on corporate roles and responsibilities, corporate users stay on topic by binding user-groups to guidance policies derived by content.

To maintain context and relevance within conversations, techniques like semantic alignment and description compression are employed. Semantic alignment assesses the alignment of conversation content with the underlying knowledge structure, while description compression optimizes the representation of knowledge, enhancing efficiency and reducing redundancy. Furthermore, the acceleration of these techniques using Graphics Processing Units (GPUs) and Accelerated Processing Units (APUs) significantly boosts the speed and scalability of knowledge-driven processes. In addition to GPUs and APUs, field programmable gate arrays (FPGAs) and application specific integrated circuits (ASICs) are utilized for high performance, scalability and increased customization.

An API provides a standard interface that plumbs information within and outside of an organization. Modern digital architectures are built on APIs that provide read, write, delete and update access to information in both structured and unstructured formats. APIs typically are the entry point for most systems and leverage standard internet protocols for interaction such as HTTP and HTTPS, and also tie into mainframes, databases and proprietary systems through protocols such as JDBC and JMS/MQSeries. These APIs are critical in enabling conversational systems and ensuring that factual information is provided to the users who chose to use language to interact with information. The combination of LLMs, APIs and Knowledge Graphs provide the crucial bridge between probabilistic language understanding and deterministic fact retrieval. Without these building blocks, unstructured and structured data value cannot be unlocked within an enterprise.

Human-in-the-Loop (HITL) verification remains integral to the validation of knowledge structures, ensuring their accuracy and reliability. In parallel, neural network training, often accelerated by GPUs, APUs, FPGAs and ASICs, enhances the scalability of knowledge graph generation. This enables the system to autonomously expand its knowledge base while minimizing the need for continuous human intervention.

To cater to diverse user needs, personalization may be introduced through user profiles, groups, and access control lists (ACLs). Each user or group may be associated with specific policies, tailoring the conversation experience to individual preferences and expertise. The efficient execution of these personalization strategies is further empowered by GPU, APU, FPGA, and/or ASIC acceleration.

The integration of LLMs, GPTs, GPUS, APUs, FPGAS, ASICs into knowledge-driven conversation guidance signifies the convergence of cutting-edge AI models and hardware, enabling organizations to navigate the data-rich landscape with unprecedented efficiency and efficacy.

In one aspect, the invention may be a dynamic application programming interface (API) discovery system for conversational interfaces comprising a processor and a memory with computer code instructions stored thereon. The memory may be operatively coupled to the processor such that, when executed by the processor, the computer code instructions cause the API discovery system to generate one or more prompts configured to advise a user of one or more permitted topics about which the user can have a conversation, receive a conversation request from the user, and select one or more relevant application programming interfaces (APIs) based on (i) the conversation request provided by the user and (ii) an assigned guidance policy. The computer instructions may further cause the API discovery system to determine a semantic alignment score that measures relevance of the conversation with respect to a selected API, and compare the semantic alignment score with a semantic alignment threshold and determine that the selected API is relevant to the conversation if the semantic alignment score is greater than or equal to the semantic alignment threshold.

The alignment score may be used to determine if conversation text associated with the conversation request aligns with one or more knowledge graphs. The one or more knowledge graphs may comprise one or more of a taxonomy, an ontology, and associative properties of the taxonomy and the ontology. The system may use one or both of (a) an API from a static list of APIs and (b) an API associated with a knowledge graph. An administrator may assign a preference for strong reliance on an API from the static API list when the semantic alignment score exceeds a strong similarity threshold, and a deference to the knowledge graph or a large language model (LLM) for validation when no match occurs with the API list. The computer code instructions may further cause the API discovery system to iteratively prompt the user for one or more API field values.

The computer code instructions may further cause the API discovery system to determine sufficiency an API field value from the user with respect to one or more of (a) permitted topics, (b) the knowledge graph, and (c) the LLM. The computer code instructions may further cause the API discovery system to invoke the API after one or more API fields have been entered. The computer code instructions may further cause the API discovery system to receive one or more API responses in response to invocation of the API. The computer code instructions may further cause the API discovery system to transform the one or more API responses into human readable formats using at least one template associated with the API.

In another aspect, the invention may be a method of implementing a dynamic application programming interface (API) discovery system for conversational interfaces, comprising generating one or more prompts configured to advise a user of one or more permitted topics about which the user can have a conversation, receiving a conversation request from the user, and selecting one or more relevant application programming interfaces (APIs) based on (i) the conversation request provided by the user and (ii) an assigned guidance policy. The method may further comprise determining a semantic alignment score that measures relevance of the conversation with respect to a selected API, and comparing the semantic alignment score with a semantic alignment threshold and determine that the selected API is relevant to the conversation if the semantic alignment score is greater than or equal to the semantic alignment threshold.

The method may further comprise using the alignment score to determine if conversation text associated with the conversation request aligns with one or more knowledge graphs. The method may further comprise using one or both of (a) an API from a static list of APIs and (b) an API associated with a knowledge graph. An administrator may assign a preference for strong reliance on an API from the static API list when the semantic alignment score exceeds a strong similarity threshold, and a deference to the knowledge graph or a large language model (LLM) for validation when no match occurs with the API list.

The computer code instructions may further cause the API discovery system to iteratively prompt the user for one or more API field values. The method may further comprise causing the API discovery system to determine sufficiency an API field value from the user with respect to one or more of (a) permitted topics, (b) the knowledge graph, and (c) the LLM. The method may further comprise causing the API discovery system to invoke the API after one or more API fields have been entered. The method may further comprise causing the API discovery system to receive one or more API responses in response to invocation of the API.

The method may further comprise causing the API discovery system to transform the one or more API responses into human readable formats using at least one template associated with the API. The method may further comprise causing the API discovery system to use the conversation request from the user and the one or more API responses make one or more additional APIs relevant to the conversation.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1A is a block diagram of example dynamic application programming interface (API) discovery and invocation system deployed within an enterprise that determines relevant APIs based on user or system conversation.

FIG. 1B is a block diagram of example dynamic API discovery and invocation system deployed cloud that determines relevant APIs based on user or system conversation.

FIG. 1C is a block diagram of a node that may be used to implement aspects of the API discovery and invocation system described herein.

FIG. 2A is a flow chart of a sequence of design time steps used to develop a knowledge graph based on API artifacts and additional source content with Human-in-the-Loop validation.

FIG. 2B is a flow chart of a sequence of design time steps used for training/tuning an LLM/GPT with API artifacts and additional source content with Human-in-the-Loop validation

FIG. 3 is a block diagram that illustrates binding between ontologies and taxonomies consumed at design time to build a knowledge graph utilized for API API discovery and invocation system.

FIG. 4 is a block diagram of internal components of an example API discovery and invocation system that may employ the techniques.

FIG. 5 is a flow chart of a sequence of steps that maybe used by the API discovery and invocation system.

FIG. 6A illustrates an example display of a policy bound to a set of users and groups at design time.

FIG. 6B illustrates an example display of a conversation policy with a reference to a knowledge graph and a an API at design time.

FIG. 6C illustrates an example of a knowledge graph that contains both a taxonomy and an ontology along with their respective binding.

FIG. 6D illustrates an example of an API specification whose operations or paths are matched based on the conversation policy.

FIG. 6E illustrates an example of an API specification that has been extended to include hints about fields and prompt questions associated with each operation or path

FIG. 7 illustrates an example display of a runtime conversation interface response to a user request with a APIs selected an invoked by the system

FIG. 8 illustrates an example display for gateway to configure multiple private and public LLMs that are used for greater confidence in responses to user inquiries

### DETAILED DESCRIPTION

A description of preferred embodiments of the techniques described herein follows. Reference will now be made to the drawings in which aspects of the techniques are given numerical designations and in which the techniques will be discussed so as to enable one skilled in the art to make and use the techniques. It is to be understood that the following description sets forth examples of the principles of the techniques, and should not be viewed as narrowing the claims which follow.

Aspects of the techniques described herein are deployed in a network for controlling interaction with conversation systems, internal or external.

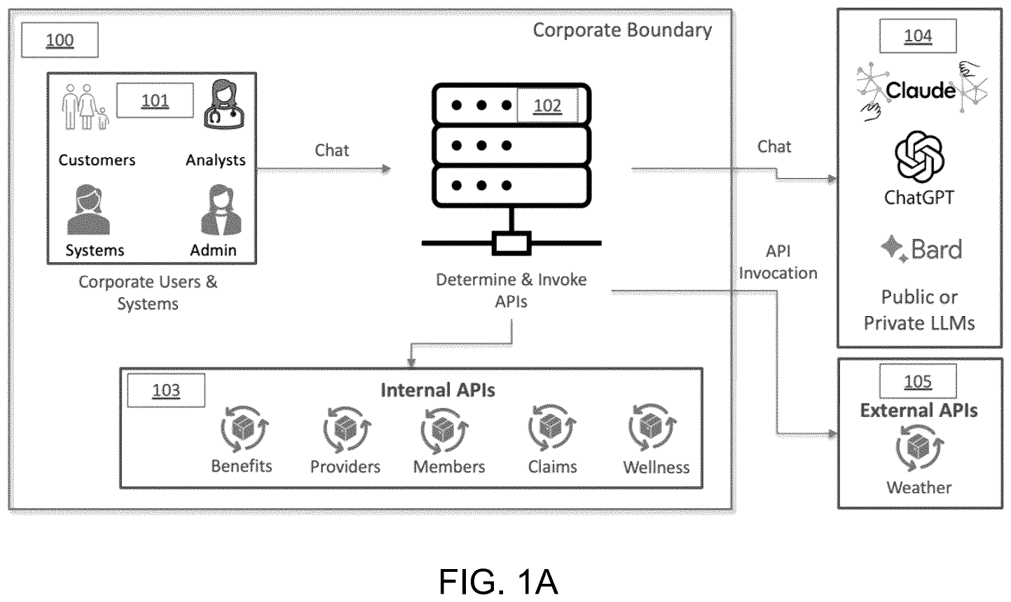

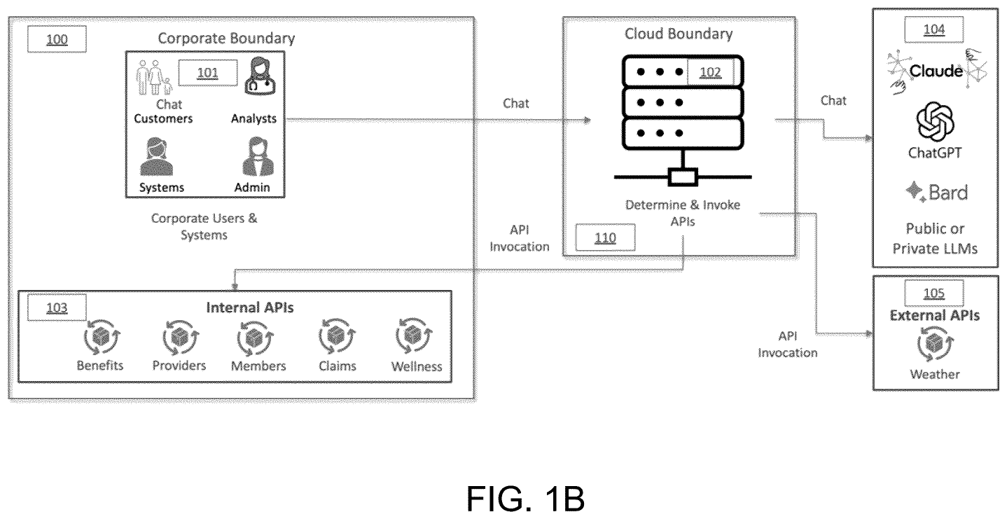

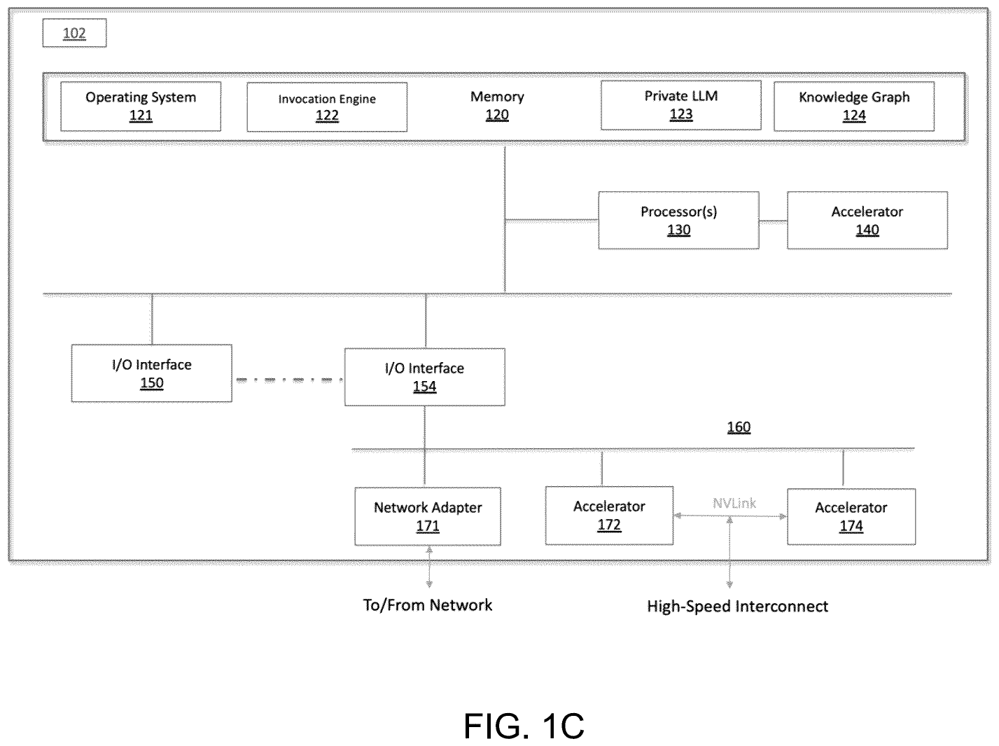

FIG. 1A is a block diagram that shows an example application programming interface (API) assist system 102 that is deployed within a corporation 100 and intercepts conversations, requests and responses from users or other systems 101 which are not permitted to call the target systems 103 directly without going through the system 102. The target systems are built on machine learning technologies, such as Large Language Models (LLM) or Generative Pretrained Transformers (GPT), examples of which are shown in 104. It should be noted that the examples of 104 can be extended to any external similar systems or internally deployed LLMs and GPTs. Beyond LLMs and GPTs, any Generative AI (GenAI) systems that include additional techniques such as Reinforcement Learning Human Feedback (RLHF) may also have a API assist system 102 intercepting communication for conversation guidance by discovering and invoking APIs that are either internal to the corporation 100 as shown in 103 or external as shown in 105.

FIG. 1B is a block diagram of the example system 102 deployed in the cloud 110 outside the corporate boundary or datacenter 100. Corporate users and systems 101 within the corporate boundary 100 are not permitted to interact with the LLMs and GPTs directly. All such conversation is directed to the system—in this case—deployed in the Cloud 110. The APIs invoked by the system 102 can be internal and proprietary to the business as shown in 103 or external publicly accessible as shown in 105.

FIG. 1C is a high-level block diagram of console node 102. Node 102 is illustratively a computer system comprising a memory 120 coupled to one or more processors 130 which is coupled via multiple input/output (I/O) buses controlled via I/O interfaces 150 to 154. 154 is one such I/O interface that controls access via the I/O bus 160 to devices 170, 171 to 174. An example of a computer system that maybe used from Lambda Inc, 2510 Zanker Road, San Jose, California 95131. Processor 130 is an illustrative conventional processor such as Intel Xeon 6448Y or AMD EPYC 9124 that can execute instructions and manipulate data contained in memory 120. 171 to 174 is an illustration of multiple Graphical Processing Units (GPUs) such as NVIDIA RTX A6000 or NVIDIA A-100 inter-connected, for example, using Nvidia's NVLink and via PCIe I/O bus 160. NVIDIA's NVLink enables GPUs to communicate with external accelerators (GPUs) over a high-speed network such as Infiniband. This enables a variety of scalable clustered configurations to meet performance needs. A more integrated accelerator 140 configuration ties with memory 120 and processor 130, called an Accelerated Processor Unit (APU), for example the Ryzen 3 3200G APU from AMD, provides an additional configuration for higher efficiency for the guidance system 102.

Memory 120 may be implemented using, e.g., dynamic RAM (DRAM) devices. Memory 120 comprises an operating system 121, recommendation engine 122, one or more private Large Language Models (LLMs) or GPTs 123, and Knowledge Graphs (KG) 124.

The operating system 121 is a conventional operating system that contains Software that enables Software, such recommendation engine 122, the LLMs 123 and the Knowledge Graphs (KG) software, to, inter alia, be scheduled for execution and to access various devices on node 102, such as network interface 170. An example operating system that may be used with the described embodiments is the Ubuntu 22.x, an open source operating system.

The invocation engine 122, one or more private Large Language Models (LLMs) or GPTs 123, and Knowledge Graphs (KG) 124 comprise computer executable instructions configured to implement aspects of the techniques described herein utilizing the example resources illustrated in FIG. 1C with special consideration given to the use of accelerators 140 used to make API relevance for conversations.

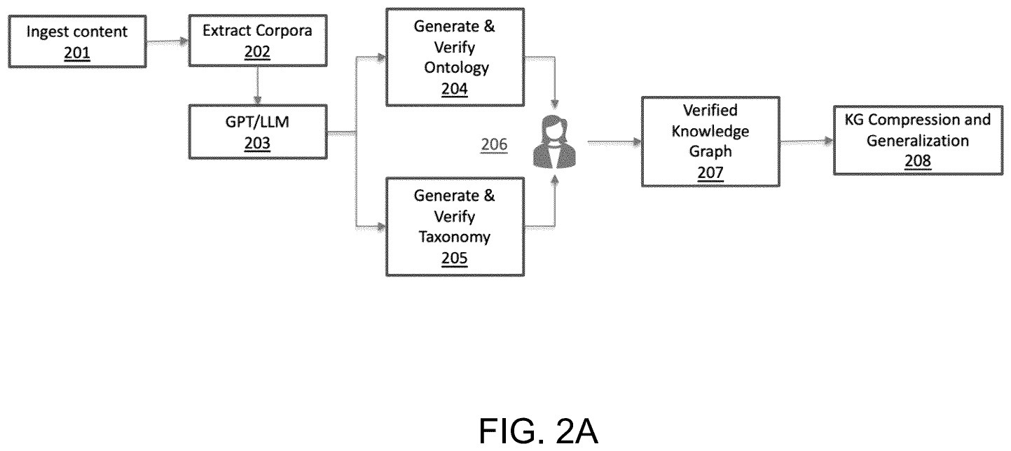

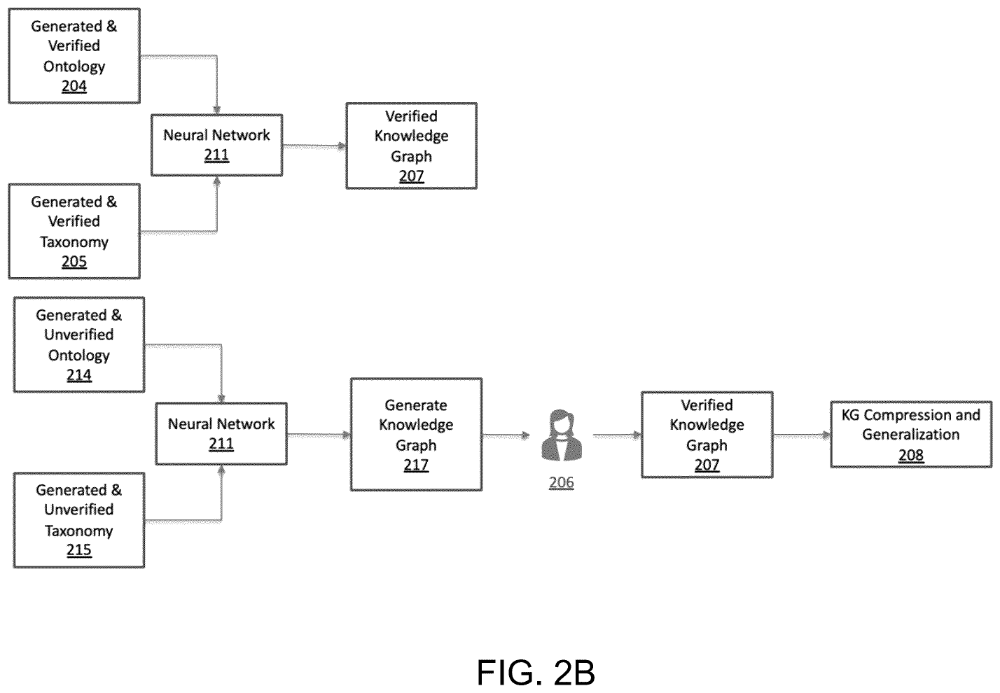

FIG. 2A is a flow chart of a sequence of design time steps used to develop a verified knowledge graph 207 based on the on source content 201 ingested during design-time. Once the content is ingested, the associated corpora is extracted 202 through standard well known techniques such as parsing for structured content and OCR for unstructured content. with Human-in-the-Loop validation.

The source content ingested in 201 consist of business documents and content in unstructured format for example PDF files, images and word documents.

Also ingested are API interface definitions typically structured documents in JSON, YAML, XML, WSDL format. Common specification such as OpenAPI Specification (OAS) is one example of an API interface definition specification used in the industry. Other proprietary structured documents such as Excel spreadsheets can also be ingested. Certain environments may not have design-time artifacts for API definitions. In such cases, 201 may ingest runtime traffic in HTML, JSON, XML or similar formats and use information embedded in the protocol headers and the payloads. These runtime values are necessary for ensuring that when the conversation system 102 is determining the APIs to invoke, it understands whether the user has answered the prompts with content that contains relevant values to invoke the selected APIs successfully.

When necessary, step 202 is used to extract the corpora before sending the information to an LLM or GPT 203. It may not be necessary to extract corpora for structured content such as JSON, YAML or XML files before sending it to the GPT/LLM.

The extracted corpora may also be obfuscated with confidential and private information removed or replaced before sending it to an internal or external LLM or GPT 203. This obfuscation process is not shown here.

Based on the content, the LLM/GPT 203 generates an ontology 204 and a taxonomy 205 that are manually verified by a Human-In-The-Loop (HITL) 206.

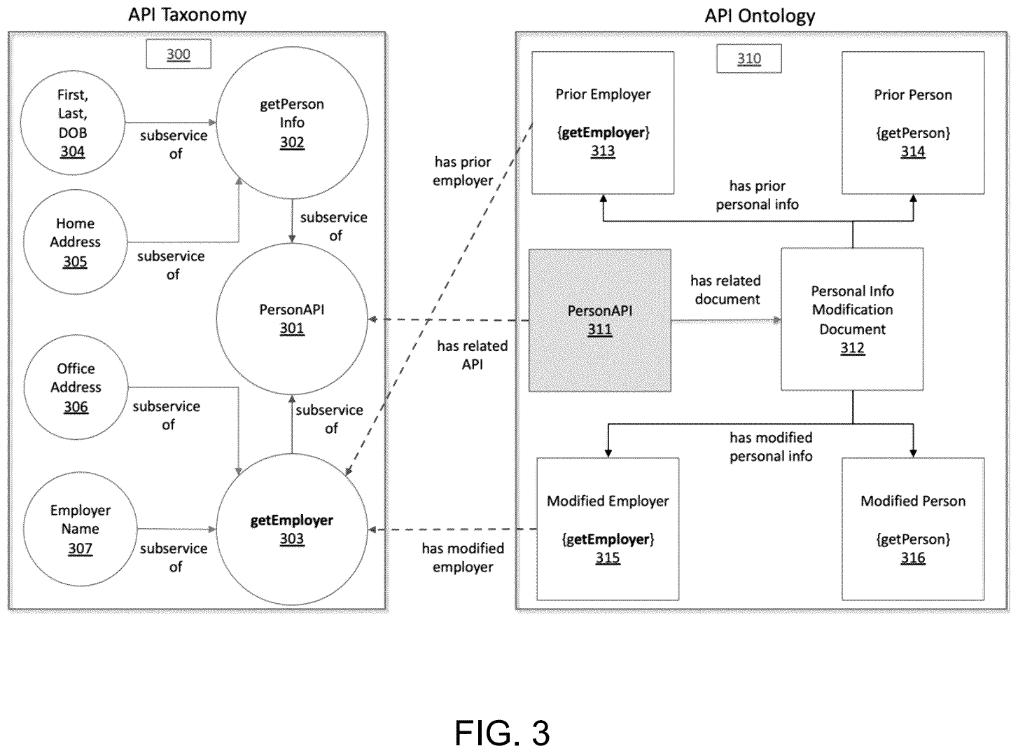

Not shown in FIG. 2A, at design time the ontologies and taxonomies generated by 203 can be resent to the GPT/LLM for binding them together. The resultant knowledge graph, an illustrative example shown in FIG. 3, binds the taxonomy and the ontologies. HITL 206 is used to verify the taxonomies, ontologies and the resultant knowledge graphs. The relationships can all be manually modified via HITL 206.

The ontologies 204, taxonomies 205 and related knowledge graphs now serve as human verified “golden records” that can then be used to automate the process as will be described later in FIG. 2B.

It should be noted that multiple ontologies and taxonomies can be generated for the ingested content, structured and unstructured, or a single taxonomy and ontology can be built that consolidates all the ingested information. The objective of the binding is to increase the confidence and ease of finding a relevant API when a user or system provides or enters a request in a conversation interface.

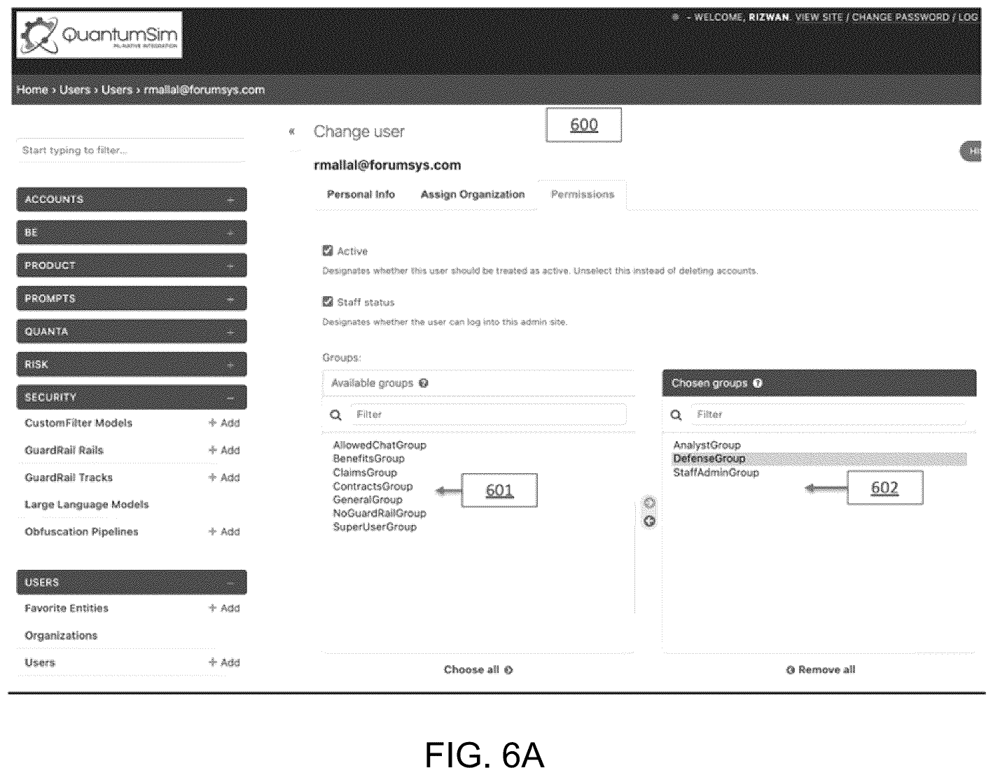

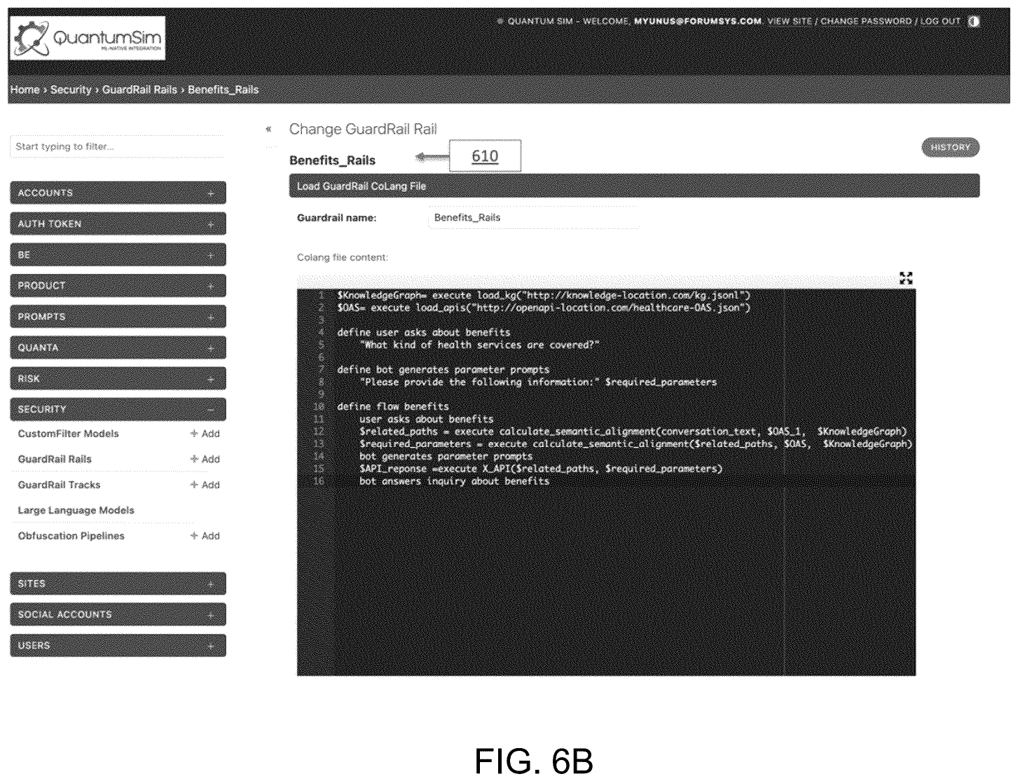

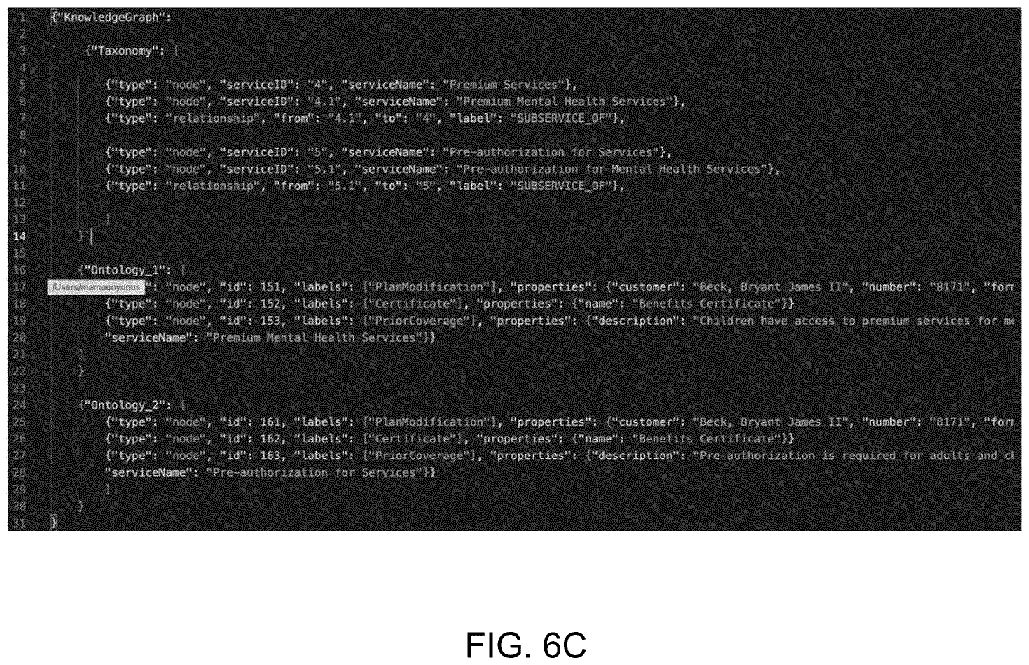

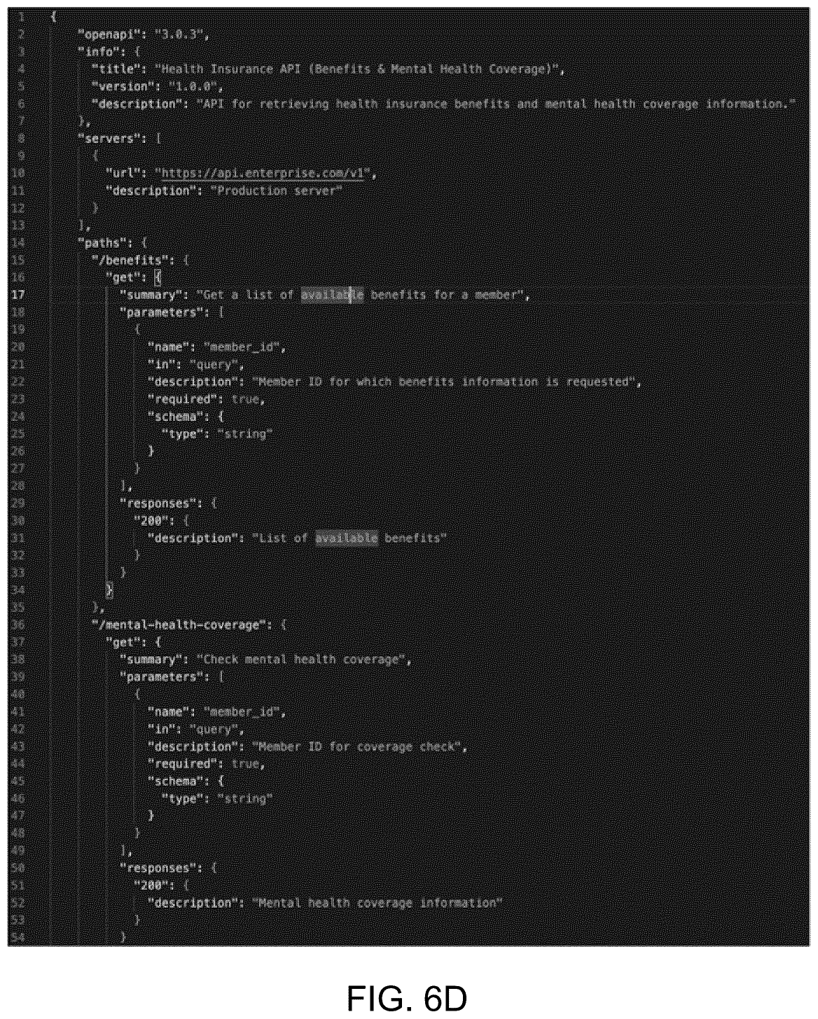

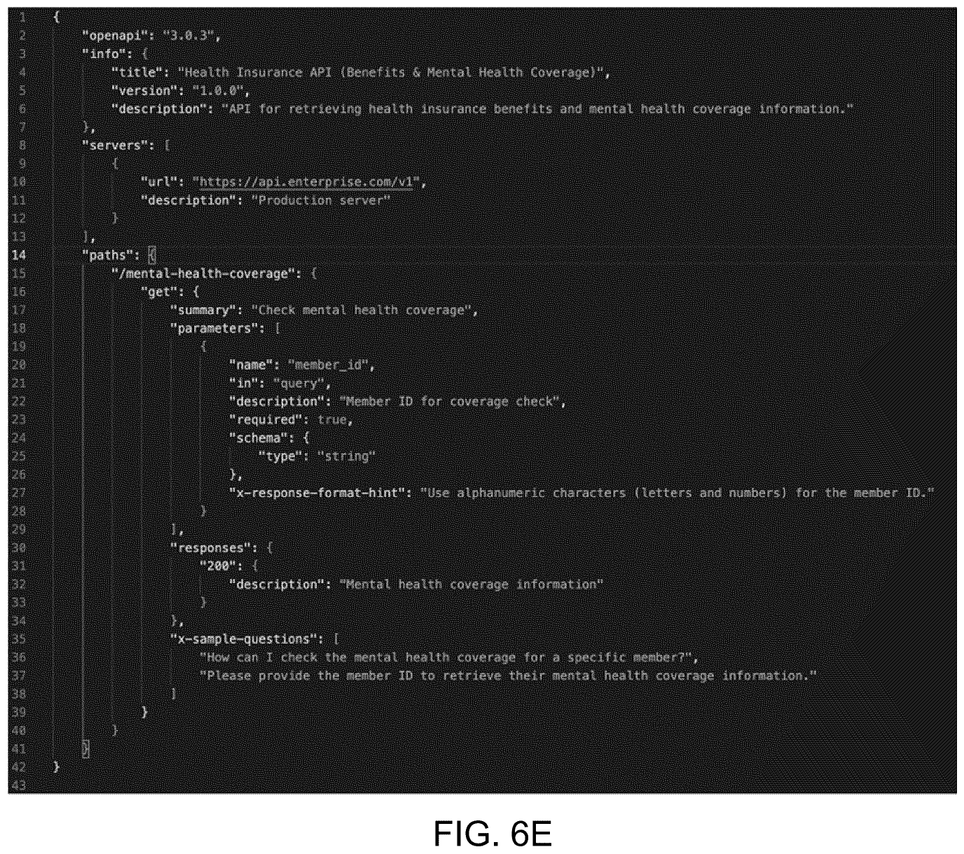

The ontology, taxonomy, and verified relationships are consolidated into a JSONL file format. This JSONL representation captures the domain knowledge via documents if available as well as API interface definitions ready for building policies as shown in FIG. 6A and FIG. 6B into the system 102.

The verified ontology, taxonomy and knowledge graph generation is followed by a compression and generalization process 208. This process is enhanced by incorporating similarity techniques to compress descriptions. This step ensures a concise and efficient representation of entities and concepts within the knowledge graph. Descriptions are generalized and compressed based on a predetermined threshold of similarity, resulting in a more compact knowledge graph.

Description Compression Policy Formulation: To implement the Description Compression Policy, the system utilizes semantic similarity algorithms to identify redundancies and similarities within entity descriptions. Descriptions that surpass a similarity threshold are compressed, replacing specific details with generalized terms. Sample code executed on node 102 for achieving this generalization and compression is shown below:

| | |
|---|---|
| 1 | from sklearn.feature_extraction.text import TfidfVectorizer |
| 2 | from sklearn.metrics.pairwise import cosine_similarity |
| 3 | |
| 4 | def compress_description |

(entity_descriptions, similarity_threshold=0.8):

| | |
|---|---|
| 5 | vectorizer = TfidfVectorizer( ) |
| 6 | tfidf_matrix = vectorizer.fit_transform(entity_descriptions) |
| 7 | similarity_matrix = cosine_similarity(tfidf_matrix) |
| 8 | |
| 9 | compressed_descriptions = [ ] |
| 10 | |
| 11 | for i, description in enumerate(entity_descriptions): |
| 12 | similar_indices = [index for index, score in enumerate |

(similarity_matrix[i]) if score >= similarity_threshold]

| | |
|---|---|
| 13 | if len(similar_indices) > 1: # Compress descriptions if |

multiple similar descriptions found

| | |
|---|---|
| 14 | generalized_description = generalize_description(description, |

similar_indices)

| | |
|---|---|
| 15 | compressed_descriptions.append(generalized_description) |
| 16 | else: |
| 17 | compressed_descriptions.append(description) |
| 18 | |
| 19 | return compressed_descriptions |
| 20 | |
| 21 | entity_descriptions = [ |
| 22 | “The American Bald Eagle is a large bird of prey.”, |
| 23 | “The Bald Eagle is native to North America.”, |
| 24 | “The Bald Eagle has a distinctive white head and tail feathers.”, |
| 25 | ] |
| 26 | |
| 27 | compressed_descriptions = compress_description(entity_descriptions, |

similarity_threshold=0.7)

| | |
|---|---|
| 28 | print(compressed_descriptions) |

As shown in line 12 above, the knowledge graph description is evaluated for similarity and then compared to a similarity threshold that can be set by the user at design time. This serves a tuning parameter for deciding the level of compression desired. A low similarity threshold can result in a higher compression. Standard generalization techniques (not described here) can be implemented for line 14. The objective of this compression is to eliminate the need for a single knowledge graph per document ingested. For example, based on the similarity threshold setting of 0.7 as shown in line 27, all entities_descriptions in line 21-25 may be compressed into a single description.

The compressed descriptions are integrated into the ontology, taxonomy and knowledge graph construction process. During the establishment of hierarchical relationships, the compressed descriptions are used to ensure that similar concepts and entities are grouped together, resulting in a more streamlined and concise representation, even when the content spans unstructured documents and structured API definitions.

Policies for selecting the relevant APIs are subsequently configured using the compressed ontology, taxonomy and knowledge graphs as shown in FIG. 6B. The system uses the generalized and compact descriptions to enhance the efficiency of semantic alignment of the conversation with the APIs.

As a user or system enters more information or retrieves information from other sources via API invocations or calls to internal and external LLMs and knowledge graphs during the conversation, the system 102 continually evaluates relevance to select a set of APIs that may be useful. If the conversation aligns with set parameters, APIs are identified as relevant to the conversation. If the user has provided the requisite information necessary to invoke one or more APIs, the invocation takes place, otherwise the system 102 presents a set of follow-on questions to guide the conversation and retrieve the required information for candidate APIs.

FIG. 2B is a block diagram for a neural network trained to generate knowledge graphs for additional source documents. The training data includes human-verified knowledge graphs and corresponding text corpora. This step is necessary to scale beyond the HITL verified content and rely on Neural Networks-such as Graph Neural Networks-to create a more comprehensive Knowledge Graph without incurring high manual labor.

This process automates the generation of knowledge graphs by using the generated and verified ontologies 204 and taxonomies 204 as input features to train a neural network 211 with the verified knowledge graph 207 as the target. The “golden” representations that are human verified as described in FIG. 2A are used to train the neural network since they represent the ground truth. Once the neural network is trained and tested satisfactorily (e.g., standard method of minimizing loss function without overtraining), new generated and unverified ontologies 214 and taxonomies 215 are sent to the trained neural network for inference. The resulting generated knowledge graphs 217 can then be selectively sampled to generate verified knowledge graphs with Human-In-The-Loop (HITL) 206. As with the manual process shown in FIG. 2A, once the knowledge graph is generated, a subsequent compression process 218 is invoked for a more optimal knowledge graph representation. Although not shown in FIG. 2A and FIG. 2B directly, the Human-in-the-Loop step 206 is also repeatable between step 207 and 208 as a validation for the compression process.

The objective of this process is to validate a small subset of the knowledge graph to ensure that the neural network is doing its job correctly. As ongoing HITL takes place, the verified knowledge graphs and their associated ontologies and taxonomies now become part of the golden representation or ground truth that can then be used to retrain the neural network and check for model drift between different versions. This ensures that all labor cost incurred by HITL is captured in the neural network for improved future results, and a reduced HITL burden as new content is ingested to create knowledge graphs for the API discovery and invocation system 102. All training and inference for the neural network 211 utilize node 102 illustrated as an example system in FIG. 1C.

FIG. 3 is a block diagram that illustrates binding between ontologies and taxonomies consumed at design time to build a knowledge graph utilized for the API discovery and invocation system. In FIG. 3, the taxonomy 300 is derived from source content such as API definitions in OpenAPI Specifications (OAS) as an illustrative example. Unstructured content such as PDF files that include as an example a person's name, address and employment information is also ingested and used to build the taxonomy 300. The content can be generalized to any domain.

Using the process and techniques described in FIG. 2A, the ingested document results in a taxonomy 300 with a primary entity, Person 301, with 2 subservices: getPersonInfo 302, and getEmployer 303. As an illustrative example, these subservices of the primary entity represent the operations or resources or paths within an API definition. These operations in turn have sub services that are definitions of objects that define the structures the operations manipulate. For example, getEmployer 303 has a subservice Office Address 306 and an Employer Name 307 that are definitions manipulated by operations, an example of which getEmployer 303 fetches or does a GET in the case of HTTP methods on employer related data. It should be noted that other methods such as POST, PUT, DELETE, etc., in the case of HTTP and other similar methods for other protocols follow a similar taxonomy representation process.

The taxonomy hierarchy can run as deep as the structured or unstructured content warrants. For the illustrative example shown in FIG. 3, the API taxonomy may run deeper than shown. For example, the Home Address 307 typically would have subservices such as Street Address, City, State and ZIP as an example. These subservices and their data types are not shown here and are readily extracted from the API definitions represented in YAML or JSON for OpenAPI as an example.

The taxonomy is hierarchical and generally fairly static since it builds a singular “subservice of” relationship between the elements listed. These elements are business objects and are grouped to meet business needs. The groupings are then subdivided for example getPersonInfo 302 and getEmployer 303 for illustrative purposes. The subdivision can continue till it captures the required elements presented in a set of ingested documents. A taxonomy 300 also serves the purpose of categorizing documents associated with elements in the taxonomy.

An ontology 310 provides a more contextual representation of the source documents and has a wider array of relationships options between the elements. Ontologies allow us to organize the jargon of a subject area-business APIs in this case-into a controlled vocabulary so as to retain the context and understanding of the document.

A Personal Info Modification Document 312 that in this illustrative example is loaded when a person has changed their employer. The document 312 has prior and modified information and a related document, PersonAPI 311.

The property “has prior personal info” captures the intent of the content in the ontology that can then be inferred by the guidance system 102. Along with the “has prior info” property, the “has modified personal info” property for Prior Employer 313 and Prior Person 312 provides the necessary understanding about the intent and understanding of the document 312.

With the taxonomy 300 and the ontology 310 in place, using techniques described in FIGS. 2A-B, a knowledge graph is then constructed to bind the ontology and taxonomy as depicted in FIG. 3 through the “has related API,” has modified employer,” and has modified personal info” properties as shown by the dashed lines connecting the API ontologies and the API taxonomy in FIG. 3.

This connection provides a unique capability for recommending new related APIs or operations based on the elements once the relationship is established between an entity in the ontology, or guiding the conversation to topics that are still relevant to the conversation, however, may not be directly related to the sources document 312. For example, 312 may have requested a change in employer name 315 only. However, based on the knowledge graph relationships, since Office Address is 306 is a subservice of getEmployer 303, the system 102 intelligently considers 306 to be a related entity, which provides the user the related API operation or subservice to invoke.

Similarly, although the user's conversation starts by asking to change employer related information, the recommendation developed by the knowledge graph provides the user guidance towards related activities such as perhaps updating personal information such as their home address through the connecting property “has related API” between the ontology entity 311 and the taxonomy entity 301.

One of the significant aspects of FIGS. 2A-B is to build and generalize the relationship between the taxonomy and the ontology as a knowledge graph with properties such as “has related API” shown in dashed lines in FIG. 3. With millions of enterprise documents ingested to build the ontology and thousands of API definitions, the knowledge graph provides unique capabilities to identify related APIs based on the conversation input and then either invoke the API if all necessary information is available or request further information from the user to complete the request.

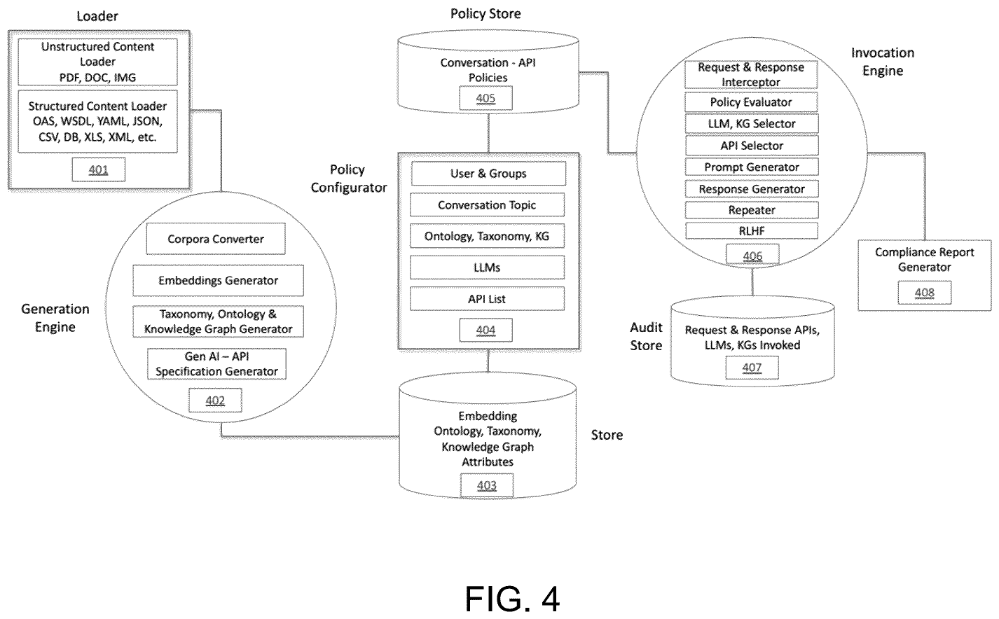

FIG. 4 is a block diagram of internal components of an example API-assisted conversation system that may employ the techniques. The Loader 401 is responsible for loading structured and unstructured content including PDF, DOC and IMG types. Structured content can be loaded as CSV files, direct Database calls or API invocation that return JSON/XML structures in real time or through batch. The loader can integrate with existing corporate systems to retrieve and load the data as necessary. API definitions typically represented in Open API Specification (OAS) or WSDL files that define the operations and request and response structures for the API are loaded via the Loader 401.

Once the content is loaded, the Generation Engine 402 is responsible for converting the content into a corpus through the Corpora Converter. Unstructured content such as images, faxes, and scanned documents go through a standard Optical Character Recognition (OCR) for conversion. Once the corpora is generated, the Embedding Generator builds an Embedding vector. Word embeddings fundamentally revolve around the idea that each word in a language can be denoted by a unique set of real-number values, essentially a vector. These vectors serve as learned representations, positioning words within an n-dimensional space. In this space, words sharing similar meanings exhibit closely situated vector representations, resulting in their proximity. While word embeddings are popular and center on the notion that each word in a language can be represented by a unique set of real-number values, it's essential to understand that embeddings can also be extended to phrases, sentences, or even larger chunks of text.

The primary objective when creating a word embedding space is to encapsulate specific associations within that space, whether they pertain to meaning, structure, context, or some other form of relationship. Word2Vec, GloVe, FastText, ELMo, BERT, USE (Universal Sentence Encoder), Transformer-based models (e.g., GPT-2, GPT-3, T5), Doc2Vec, Roberta, XLNet, DistilBERT, ALBERT, Sentence-BERT, OpenAI are a few examples of embedding engines that generate vectors with dimensions ranging from 50 to over 12,228.

Within the Generation Engine 402, the Taxonomy and Ontology generator is used to take the content corpora, send it to an external or internal LLM/GPT to have it generate the preliminary taxonomies and ontologies in a designated format such as JSONL. This component then utilizes the HITL process described in FIG. 2A and its automation in FIG. 2B to verify the taxonomies, ontologies and their related knowledge graphs and then utilize neural networks to automate this process. The generated ontologies, taxonomies, knowledge graphs along with the embeddings and original corpora and content are all stored in a database 403. This database can be a single database or a combination of databases. For example, a vector database such as Pinecone, Weaviate, Chroma, or Milvus can be used along with databases designed especially for knowledge graphs such as Neo4J, Amazon Neptune or GraphDB. A single database such as PostgreSQL may also be used as a store.

Within the Generation Engine 402, the GenAI-API Generator is responsible for extending the standard API specifications for example OAS or WSDL to include AI related information. This information can be statically curated by an API-AI developer by adding business context based tags and labels or by adding inline or via references knowledge graph information for the API as granularly as desired. For example, a developer may choose to add a reference in the API specification that includes the Prior Employer entity 311 shown in FIG. 3. By doing so, the API specification is now extended for improved matching and discoverability. The GenAI-API generator also takes a set of sample questions to help guide the conversation so as to extract the necessary information to invoke an API.

Using similar techniques as described in FIG. 2B, once a set of APIs have been curated using Human-in-the-Loop (HITL), a new API specification can then be extended via automation to generate the related artifacts and references to the Knowledge Graph entity with its related subgraphs.

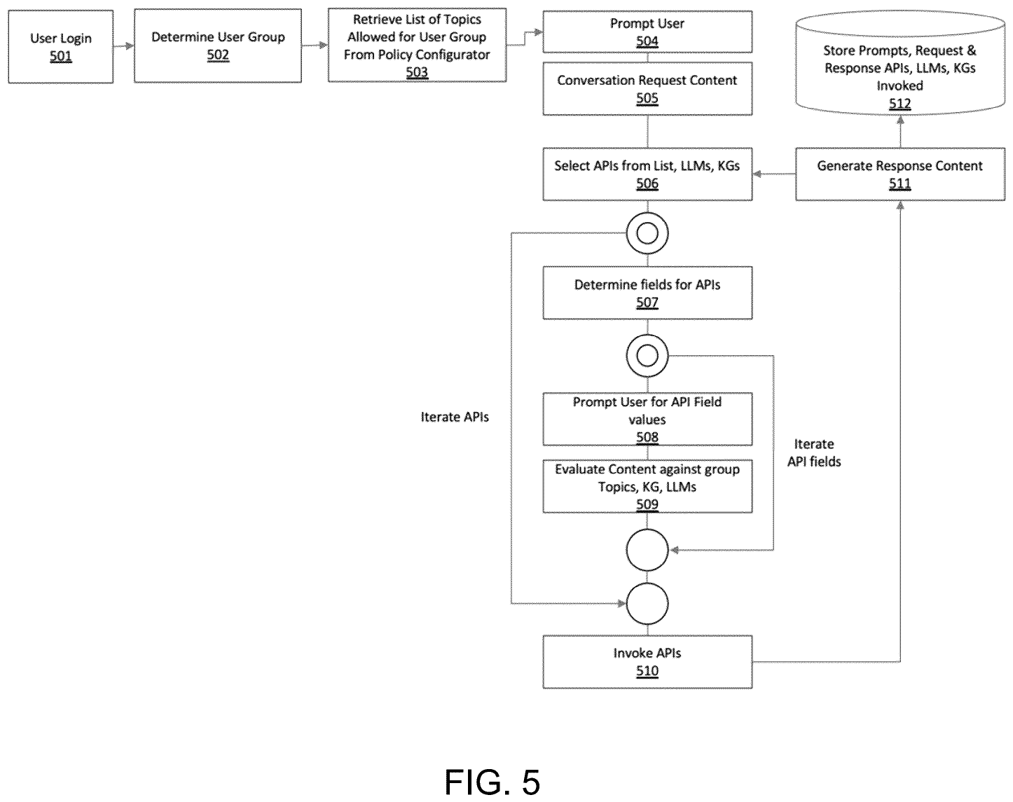

The Knowledge Graph generated in 402 serves as a key component of the API-assisted conversation system since it includes business content, API information as well and runtime values for the APIs at the field level. This is essential in determining, as shown in FIG. 5 below, whether the user has provided the necessary information during a conversation to invoke an API or a set of APIs. The resulting response samples are also tied to the Knowledge Graph so that newer APIs can be added to the list of relevant APIs dynamically as the responses come back from the invoked APIs.

The Policy Configurator 404 is a design-time component. It serves as the heart of the knowledge-driven conversation guidance system in the development of conversation policies based on the insights derived from the extracted knowledge graph and the constructed taxonomy, ontologies and knowledge graphs. These policies are sets of rules, guidelines, or recommendations that steer the direction of conversations as API are recommended and invoked. They ensure that the interactions remain contextually relevant, accurate, and aligned with the available knowledge by utilizing factual APIs that are accepted as a source of truth with an enterprise.

The Policy Configurator 404 ties user groups with the ontologies, taxonomies and knowledge graphs in a way that guides the users to relevant conversations and related APIs selected from the subcomponent API List. For a group of users once the subcomponent Conversation Topics are configured, relevance thresholds settings are used with NLP techniques to map extracted entities within a conversation to nodes in the knowledge graph. Semantic alignment scores are then calculated to measure an API's relevance to the conversation by comparing it to the thresholds set at design time. APIs with alignment scores exceeding a predefined threshold are considered relevant.

The Policy Configurator 404 also enables the administrator to select public and private LLMs/GPT for a user group. The selection of the LLMs ensures that the users are only interacting with approved external or internal LLMs. For the relevant API selection process, the system is designed to leverage a custom knowledge graph that does not leave the corporate control and is built on proprietary corporate data. The system 102 from FIGS. 1A-B-C therefore guides the conversation with external and internal LLMs/GPTs based on the knowledge inherent in corporate information along with the factual information extracted from invoking relevant APIs. The policies configured in 404 are subsequently stored in the Policy Store 405.

The Invocation Engine 406 loads policies from the Policy Store 405 for determining the set of APIs to invoke for the conversation at runtime. Its request and response interceptor subcomponent intercept the conversation between the user or system making a request to LLMs/GPTs 103. The request is sent to the Policy Evaluator subcomponent that determines the applicable policies based on the user identity and the user request input. The LLM & KG Selector subcomponent determines the associated LLMs and knowledge graphs with the policy with the intent of using them to dynamically determine the relevant APIs to invoke. The policies also contain a static list of APIs that have been curated and stored in the Policy Configurator 404. The subcomponent API Selector of 406 is responsible for determining a subset of APIs that are relevant to the conversation from the static API List as well as the dynamic ones retrieved from the knowledge graph and LLMs based on a predefined alignment or similarity threshold.

Once the APIs are selected, the Prompt Selector is responsible for determining the prompts presented to the user to satisfy one or more of the APIs required input fields. As soon as one API has all required fields, the API is invoked, and the response is formatted based on a response templated in the Policy Store associated with the relevant policies. The intent of the Response Generator subcomponent is to take JSON or XML type responses from the APIs and format them in human readable form. A policy can have a template for a single template per API or have templates for when two or more APIs are invoked, and the system has to aggregate the information coming back from the multiple API responses.

As responses return, the information embedded in these responses are then evaluated to see what other APIs match to further add factual information into the conversation. As the conversation evolves, more APIs become relevant based on the user input, prompt generation and the API responses. The Repeater subcomponent ensures that the user continues to get more information from a wider array of APIs based conversation.

The threshold for relevance determination can be dynamically adjusted based on the specifics of the conversation or the user context. For instance, a novice user might have a lower threshold than an expert, ensuring that the system remains adaptable to different user levels. The thresholds may also be associated with user authorization levels. The user or system 101 can provide feedback whether the dialogue was allowed or terminated incorrectly. This feedback captured by the RLHF subcomponent of 406 is then stored in the Audit store 407 to be used for further training and policy refinement in conjunction with the knowledge graphs.

All requests and responses along with any transformed states such as API requests and responses are stored in the Audit Store 407. Compliance and security teams may then use the compliance report generator to audit reports to ensure compliance to corporate policies around privacy and ethics. The reports can also be used to further adjust the API-assist engine policies.

FIG. 5 is a flow chart of a sequence of steps that may be used by the system with users or systems authenticating at step 501 with the system 102. Once the user or system identity is established, the user group is determined in step 502 based on the policies in the Policy Store 405, which also binds the user groups to conversation policies that are configured at design time using the Policy Configurator 404. A list of topics that are permissible for the user are provided in step 503.

Based on the relevant topics for a user, the system 102 generates a prompt or set of prompts in step 504 to advise the user of the topics they can have a conversation about. In step 505 the user enters a request. The conversation request content 505 is then sent for evaluation in the Invocation Engine 406 that then determines the relevant API or set of APIs in step 506 based on the policies set in the Policy Configurator.

Step 506 evaluates a relevance of the content entered by the user to the set of API that either exist statically in the Policy Store 405, or the LLMs or knowledge graphs that have been associated with the policy. If the relevance threshold is met for an API or set of APIs in 506, the API or set of APIs are selected.

The step 506 starts with a semantic alignment and API relevance determination process such that during conversations, the system employs NLP techniques to map conversation entities to nodes in the knowledge graph, LLMs or API Lists. Semantic alignment scores are calculated to measure the relevance of the conversation with respect to the APIs registered with the system. Sample code to implement such an API relevance comparison between the content and the knowledge graphs entities is shown below for illustrative purposes:

| | |
|---|---|
| 1 | import spacy |
| 2 | |
| 3 | def calculate_semantic_alignment(conversation_text, |

knowledge_graph_entities):

| | |
|---|---|
| 4 | nlp = spacy.load(“en_core_web_sm”) |
| 5 | |
| 6 | conversation_tokens = nlp(conversation_text) |
| 7 | knowledge_tokens = [nlp(entity) for entity in |

knowledge_graph_entities]

| | |
|---|---|
| 8 | |
| 9 | alignment_score = 0 |
| 10 | for conv_token in conversation_tokens: |
| 11 | for kg_token in knowledge_tokens: |
| 12 | alignment_score += conv_token.similarity(kg_token) |
| 13 | |
| 14 | return alignment_score / (len(conversation_tokens) * |

len(knowledge_tokens))

As shown in line 14 above, an alignment score is calculated to determine if the conversation text aligns with knowledge graphs which may include taxonomy, ontology and properties as described in FIG. 3. The knowledge graph is built using business content and API definitions along with sample API requests and responses. Thus, this technique provides a quick narrowing down to the subsection of the knowledge graph where the associated APIs may reside. This technique checks for similarity between the knowledge graph tokens and the conversation as shown in line 12 and aggregates the alignment score across all conversation and knowledge graph tokens before normalizing it and returning it line 14.

Although not shown in the sample code above, this technique is fully extensible and utilizable for a static list of APIs that are associated with the user group as determined by 503. The alignment score can incorporate a combination of a static list of APIs as well as the APIs retrieved from the knowledge graph with techniques such as weighted averages between the two alignment scores as an illustrative example. At design time, an administrator can configure a preference in 503 to rely more on the static API list when there is a strong similarity match with the conversation and only defer to the knowledge graph or an LLM for validation when no match occurs with the API list.

Within step 506, the relevance is then determined by the semantic alignment score obtained from the alignment calculation in line 14 above and comparing it to the API relevance threshold shown in line 3 below. APIs with alignment scores exceeding a predefined threshold are considered relevant to the conversation. Sample code for illustrative purposes to implement such as relevance score and threshold comparison is shown below:

| 1 | def is_conversation_relevant(conversation_text, |
|---|---|
| knowledge_graph_entities, relevance_threshold=0.6): | |
| 2 | alignment_score = calculate_semantic_alignment |
| (conversation_text, knowledge_graph_entities) | |
| 3 | return alignment_score >= relevance_threshold |

The threshold for API relevance determination can be dynamically adjusted based on the specifics of the conversation or the user context. Relevance thresholds may not be static for all members of an enterprise with varying responsibilities and functions. For instance, a novice user might have a lower threshold than an expert, ensuring that the system remains adaptable to different user levels.

| | |
|---|---|
| 1 | def dynamic_relevance_threshold(user_experience_level): |
| 2 | if user_experience_level == “novice”: |
| 3 | return 0.5 |
| 4 | elif user_experience_level == “expert”: |
| 5 | return 0.7 |
| 6 | else: |
| 7 | return 0.6 #Default threshold |
| 8 | |
| 9 | user_experience = get_user_experience_level( ) |
| 10 | threshold = dynamic_relevance_threshold(user_experience) |
| 11 | is_relevant = is_conversation_relevant(conversation_text, |

knowledge_graph_entities, threshold)

Although a couple of user experience levels are shown in the code above in lines 2 and 4, the concept can be extended to an enterprise identity authentication and authorization system like an LDAP store that can be integrated with Policy Configurator 404 for multiple-level employee and member roles within a corporation.

Once a list of relevant APIs is established, the system reorders the relevant list based on the highest to lowest matched API relevance. It then loops over each API and determines the required fields to invoke an API in step 507. The system then iterates through the list of fields for an API and ascertains whether the user has entered sufficient information to invoke the API by using similarity techniques shown above to match the input fields and sample values configured at design time that exist in the Policy Store 405 with the conversation content.

If the user has not entered all the information necessary for invoking APIs in the list, the system generates a set of prompts in step 507 that are either stored in the Policy Store 405 developed by the Policy Configurator 404 using the Prompt Generator, a subcomponent of 406. The Prompt Generator utilizes the policies that contain a set of static prompts or to use a combination of the knowledge graph and the LLM along with the static prompts to generate a more contextualized prompt that can capture information about one or more fields with missing values.

The content returned by the user because of the prompts in step 508 is then then evaluated in step 509 against the topics, knowledge graphs or LLMs or a combination of these components to determine if the content provided is sufficient for the target API field. This process is then repeated in a loop for all the API fields that need to be available to invoke the API. In step 510 an API or a set of APIs are invoked.

The responses of APIs are typically in the form of JSON or XML messages. These are then transformed into human readable formats using templates that are associated with the APIs as shown in step 511. The templates accommodate both positive and negative responses where positive responses contain useful business information whereas negative responses are errors or data not found (DNF) type responses. The templates can be for a single response or aggregated API responses.

As the conversation progresses with information from the APIs now integrated within the conversation, the combination of the user input in step 505 and the API responses provided in 511 extend the informational sphere to make more APIs relevant to the conversation as shown by step 506 taking input from the user as well as the API responses 511. This information expansion loop can continue as long as the user or external applications continue to converse with the system 102.

FIG. 6A illustrates an example display 600 of a policy bound to a set of users and groups at design time. A policy shown in FIG. 6B and FIG. 6C stored in the Policy Store 405 is selected and associated with a group of users 602 using the Policy Configurator 404. This binding at design time is also stored in 405 along with the API policy. All available and unassociated user groups appear in 601.

FIG. 6B illustrates an example display of a policy configured based on a knowledge graph at design time including taxonomy, ontology through a reference to a knowledge graph as shown in line 1. FIG. 6C is an example of a knowledge graph and related properties that is utilized by the HealthCare policy 610.

In addition to the knowledge graph reference in FIG. 6B, line 2 also has a reference to a location from where the API specification can be loaded. The sample specification that this reference points to is shown in FIG. 6D. The policy defined in 610 as shown in FIG. 6B ties one or more API definitions along with one or more knowledge graphs along with the related API discovery process to a group of users so that only these users are entitled to access the APIs during the conversation. The APIs themselves may have their own authentication provisions that can be configured or mapped based on the user login process shown in FIG. 5.

Line 11 in FIG. 6B is where, based on semantic alignment as one possible technique as explained in code snippets shown in FIG. 5, the conversation is aligned with the list of registered APIs from line 2. As the related paths are selected based on the user input a subset of operations emerge. For example, if the user is inquiring about mental health benefits, the “/mental-health-coverage” path shown in line 36, FIG. 6D is selected as a matching API resource to invoke. In line 13, the system determines through a similar semantic alignment whether conversations contain necessary information to invoke the API then the system. The required fields are then prompted to the user as shown in line 14 to gather all required information.

Line 15 shows the selected API along with its fields being invoked. The ability to dynamically select the API and gather its related fields for invocation by consulting the API specification or the knowledge graphs is the core tenant of this system as it alleviates hardcoding each API call separately and continues to expand or reduce the scope of available APIs as the conversation progresses.

A strong value semantic match with an API with a configurable threshold set to a high value, for example >0.9, provides confidence to the systems to select highly relevant APIs to the conversation. However, if the match does not meet the threshold, the knowledge graph is consulted using similar techniques to improve the chances of discovering relevant APIs. The knowledge graph is trained using business content as well as the API definitions and sample request-response pair. It can therefore serve as a more sophisticated source for matching conversations to APIs when the initial semantic check against the API list returns low value matches.

Another significant feature of utilizing the knowledge graph is that it has sample input content formats for example “member-id” numbers that it has modeled because of ingesting sample requests and responses. It can therefore provide hints to the user on the format of data to enter as a part of prompt generation.

FIG. 6E illustrates an example display of extending an OpenAPI specification to include hints for questions that a conversation system generates to gather more information from the user. For example, if the user inquires about mental health coverage and the system matches the initial user conversation input with “/mental-health-coverage” path as shown in line 15 of FIG. 6E, the user can be prompted for further information by the conversation system through using possible questions under line 35. For example, if the system is missing member information, it matches with the question “Please provide the member ID to . . . ” as shown in line 37. Furthermore, if the user enters an incorrect format, then the system utilizes line 27 to provide a format hint to the user. The system can combine both the sample question and the format via a Large Language Model to generate a composite question for the user and gather information through minimal and more condensed interaction. These techniques may be extended to:
a) Add any number of API and fields
b) Response templates, including error templates that provide a human readable format for json/XML responses
c) Reference to external knowledge graphs that help bind the API specifications with knowledge graphs and therefore the business content encompassed and sample request and responses incorporated in the knowledge graphs
d) Reference to Large Language Models that have been tuned with information embedded in these APIs.

The advantage of extending API specification such as OpenAPI 3.0 is that enterprise consuming applications can now have conversational capabilities integrated with a single configuration files that also points to internal and public Generative AI platforms and technologies such as Large Language Models or Foundational Models as well as knowledge graphs and related ontologies and taxonomies. Users can interact with enterprise data both structured and unstructured via this specification.

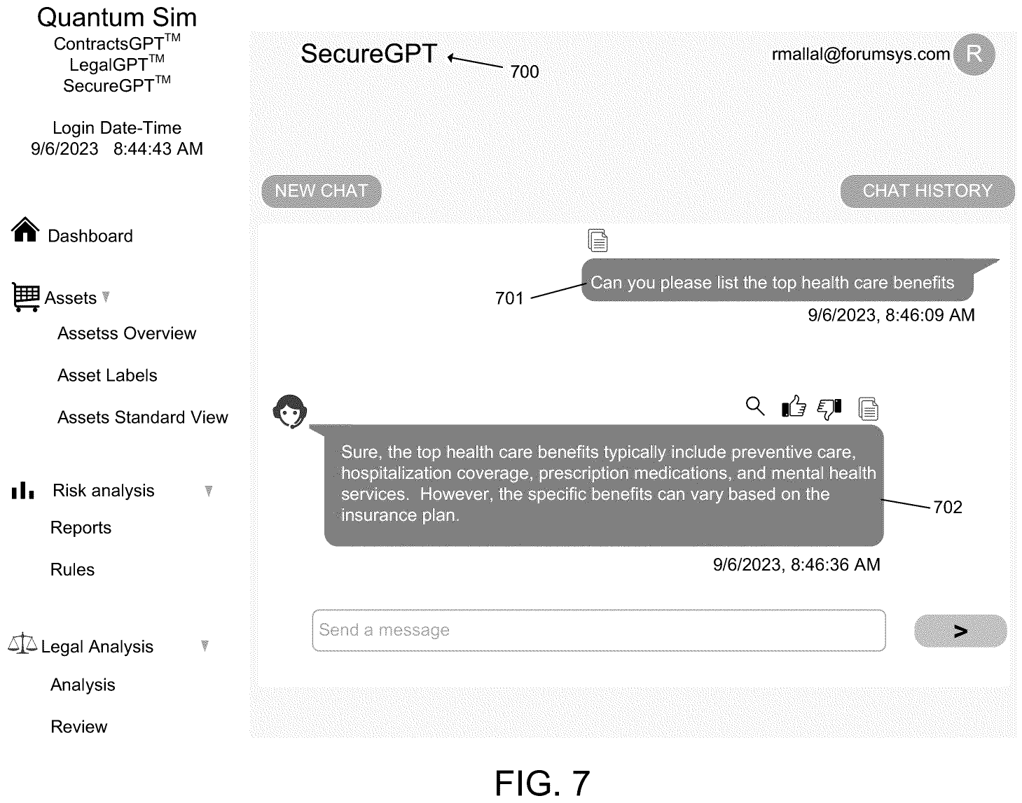

FIG. 7 illustrates an example display of a runtime conversation interface 700 with a relevant request 701 and a relevant response 702 that is enforced by enforcement engine 406. Since the question request is related to healthcare, as an example, the engine evaluates this using the steps described in FIG. 5 and determines that it is within the thresholds set for invoking underlying APIs determined by the engine 406. The APIs are invoked as the information is gathered and newer APIs become available for invocation as the conversation progresses.

The described embodiments are directed to a system and technique to dynamically discover APIs as a user enters a chat or conversation request in a prompt. The APIs are usually defined via an interface definition like OpenAPI specification which contains operation names as well as input and output field definitions.

The system may be required to consume existing specifications defined within an enterprise or build a brand new API. For both scenarios, one of the objectives of the described embodiments is to also add entities and definitions within the API specification (such as OpenAPI) that enables a match based on the user conversation more readily for request, response and guiding the conversation based on the response received from the API including valid and erroneous responses.

We can also envision that a taxonomy, ontology or a knowledge graph can be leveraged to extend the API specification such as OpenAPI based on corporate knowledge. The API spec can also contain templates for human readable specifications and error handling. It may also include a set of questions when further information is required from the user or when a response does not contain valid or useful information such as data not found.

As the user enters the information, with a high degree of confidence, the system can match the APIs that can retrieve related information for corporate systems or external APIs tied to them or any API. The APIs themselves can be listed in an API repository using Taxonomy, Ontology and Knowledge graph concepts such that identifying related APIs is more precise from a list of known APIs.

### Design/Configuration

This repository of APIs can be created in a process that includes using a public or private LLM to first generate a Taxonomy and an Ontology for the APIs and their artifacts, and then use a human-in-the-loop process to ensure that these generated Taxonomies and Ontologies are accurate and combined as necessary to create a knowledge graph.

Further, a relationship between these Taxonomy and Ontology entities and properties may be created and verified. This now becomes the Knowledge Graph for the API. The system and technique of building a knowledge graph for a collection of APIs is one of the central tenants of the described embodiments.

This build out process can leverage internal and external LLMs, however it has to be certified by a human in the loop. Also, other corporate knowledge graphs, corporate content can be leveraged in building out the knowledge graph for a list of APIs that can then be used during runtime.

Relationships between API based on business function and invocation sequence is also captured in the Knowledge Graph with properties such as “is_invoked_by” or “invokes” as illustrative examples.

Also contemplated in this system and technique is the tuning of an LLM based on APIs as inputs so that during design time or runtime, the knowledge graph can be used in conjunction with the API LLM.

As new APIs are added to the system, a neural network such as a graph neural network trained on prior APIs as ground truth are used to help discover and recommend relationships between the new API and the existing set of API. This may then be optionally validated by the human and added in the Knowledge Graph.

Another mechanism to leverage APIs is to associate the relevant APIs with guidance or guard rail policies. Capabilities may be provided at design time to set guidance policies using a process as follows: “FIG. 6B illustrates an example display of a guidance policy configured based on a knowledge graph at design time including taxonomy, ontology and related properties. The HealthCare guide 610 consists of details related to the Taxonomy 611 and the Ontology 612 and the relation between them as displayed in line 18 with “serviceName” pointing to a Taxonomy property “serviceName” with value “Premium Mental Health Services” on line 5 that is a service of the root taxonomy entity “Premium Services” on line 4 in this illustrative example.”

The concepts can be extended to add the APIs permissible for invocation for the guidance policy either by inlining the API name as well as all the specification artifacts or through a reference to registered APIs that are within the system or reside in some external repository. Once we have a robust knowledge graph and an LLM based on the source APIs and related corporate content, we are now ready to start interacting with these APIs via a chat or conversation interface.

### Runtime

As the user or system provides information, the knowledge graph and LLMs are invoked to see which APIs are closely related. It provides feedback to the user whether enough information has been provided to retrieve information from one or more APIs. The feedback that be in a completion meter display, or responses from the LLM for further information as a set of requests.

The system then invokes the matched APIs and provides a response to the user based on a human readable template. The response template can be built and stored along with the API externally or as an extension of the specification.

Multiple related APIs can result in single and composite templates. Error templates can be used when the API does not return data or errors out. The error templates contain follow on prompts to help guide the conversation. For example, if the user asks “Who do I go to for acupuncture in Lansing, MI?” and the system finds the related API and invokes it with a correct response that has no data since there are no acupuncture specialist in Lansing, then the error template provide a human readable response and has follow on prompts such as “Since there are no providers in your city, which other town would you prefer?”

Once a response comes back from the API or APIs using the designated response template, the user can choose to ask the LLM to aggregate the information or have it aggregated by default. As responses arrive, the system has more and more APIs that can engage with the user with no or minimal additional information, as long as the user is authorized to to invoke those APIs. This results in a Chain-of-APIs or Tree-of-APIs that are invoked for a user much like Chain-of-Thought and Tree-of-Thought.

How many APIs get called can also be controlled on the threshold of matches based on the user input and looking at API information in the knowledge graph or LLM. The described embodiments are not restricted to a single LLM or Knowledge Graph. Multiple can be used based on the business requirements. The system may store authentication information required for invoking the LLMs and based on user access roles, a user request may align with a set of APIs that the users may not have permissions for. The check for membership can be made before invoking the API or after invoking it.

### Gateway for Multiple APIs, LLMs, and KGs

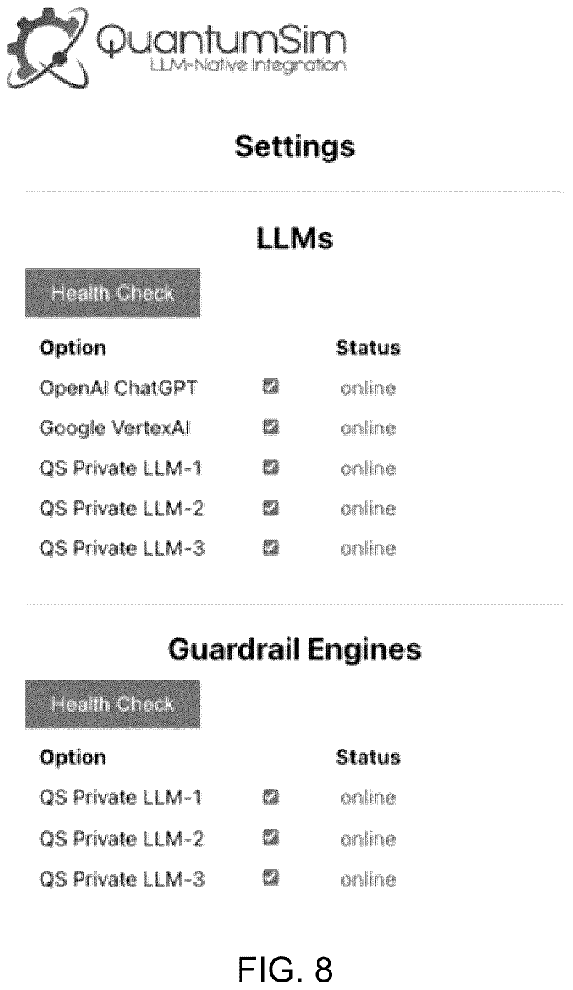

For a factual, comprehensive, and extensible conversation system, the engine 406 acts like a gateway between multiple APIs, LLMs and KGs. FIG. 8 shows an example illustration of how multiple LLMs are configured within the system. A multi-LLM, API, KG gateway would be a system that facilitates the interaction and integration of multiple knowledge stores. The innovative features of this patent could include:
1. Model Integration: The gateway allows for seamless integration of multiple LLMs, KGs, and APIs, enabling the combination of their unique strengths and capabilities. This could lead to improved performance and versatility in natural language processing tasks.
2. Dynamic Model Selection: The gateway could incorporate an intelligent system to select the most suitable LLM, KGs and APIs statically or dynamically for a given task based on factors such as the nature of the task, the language used, and the specific requirements of the user.
3. Scalability: The gateway is designed to easily accommodate an increase in the number of LLMs or the complexity of tasks, making it highly scalable. This ensures that the system can handle future growth without requiring significant upgrades.
4. Enhanced Security: The gateway incorporates advanced security features to protect the privacy and confidentiality of the data processed by the LLMs, KGs, and APIs.
5. Automated Model Management: The gateway includes automated features for managing the LLMs, KGs, APIs such as load balancing and fault detection. This reduces the need for manual intervention and improves system reliability.
6. User-Friendly Interface: The gateway includes a user-friendly interface that allows for easy configuration and management of the LLMs, KGs and APIs and their tasks.
7. Interoperability: The gateway is designed to be compatible with LLMs, KGs and APIs developed by different providers, enhancing its versatility and applicability.
8. Reliance and Reliability: The gateway incorporates a system for cross-validation among multiple LLMs. When a task is processed, it is run through all available LLMs. The responses are then compared and analyzed to determine the most reliable output. This mechanism increases the confidence in the generated content and ensures a higher level of accuracy and consistency. It is akin to the Byzantine Generals Problem (BGP) in distributed computing, where agreement must be reached among multiple systems to ensure a reliable outcome.

### Extending Byzantine Generals Problem to Cluster of LLMs and Micro-LLMs Managed by a Gateway

### Objective

The objective of this subsection is to address the reliability of a cluster of Language Model Machines (LLMs) and federated micro-LLMs in executing tasks, specifically effective responses to prompts and the fine-tuning process directed by an LLM application like Quantum Sim. This involves leveraging the collective power of multiple LLMs for reliable and higher-quality prompt responses and fine-tuning, despite the possibility of some LLMs and micro-LLMs going rogue or becoming untrustworthy.

### Problem

The problem at hand encompasses the potential unreliability of certain LLMs and micro-LLMs within a cluster during fine-tuning, as well as during the process of detecting whether a question has been answered effectively in one-shot or multi-shot learning. Factors such as faulty hardware, resource leaks, or token width limitations may lead some LLMs and micro-LLMs to disobey commands, truncate responses, or inject incorrect prompts, which could jeopardize the learning and inference processes.

### Solution

To address these challenges comprehensively, we propose applying the concept of the Byzantine Generals' Problem (BGP) to both the cluster of LLMs and the federated micro-LLMs. The BGP, a foundational problem in distributed systems, is utilized to ensure that a majority of loyal LLMs and micro-LLMs agree on commands and responses despite potential disruptions caused by untrustworthy LLMs and micro-LLMs.

### Framing the Problem

Fine-tuning: Similar to the original concept, we frame the challenge of fine-tuning as deciding whether to “fine-tune” or not. The LLM application acts as a commander issuing the “fine-tune” command to the cluster of LLMs. The trust factor comes into play as the majority of loyal LLMs need to reach a consensus on “fine-tune,” even if some untrustworthy ones decide to abstain or disrupt the process.

Detecting Question Answering Issues: In the context of one-shot or multi-shot learning, a challenge arises when receiving LLMs have token windows that are too small to accommodate the entire prompt content, resulting in truncation, poor responses or complete failure to respond by the LLM. However, as long as a majority, as defined by BGP, can loyally respond to the command (i.e., the prompt with the multi-shot or one-shot data), the micro-LLMs that are not loyal due to token width limitations or prompt injection issues will be ignored and corrected by the loyal micro-LLMs.

### Hardware Enhancement

To efficiently handle the exchange of messages and responses among all LLMs and micro-LLMs in various permutations, we continue to utilize specialized GPU buses like NVLink or Infiniband, which interconnect all GPUs running the LLMs and micro-LLMs. These buses accelerate the message-passing process and optimize overall performance.

This concept addresses both the reliability of LLMs in fine-tuning and the effectiveness of micro-LLMs in question answering, all while ensuring that a majority of loyal components reach consensus despite potential disruptions. The BGP is leveraged as a unifying framework to achieve these objectives, enhancing the overall efficiency and accuracy of language model applications.

This innovative technique not only enhances the reliability of the system but also provides a robust method for error detection and mitigation. It leads to significant improvements in the quality of the outputs generated by the LLMs.

### Advantages of the Extended Approach

Enhanced Reliability: By applying the Byzantine Generals' Problem (BGP) concept to both the cluster of LLMs and federated micro-LLMs, the proposed approach significantly enhances the reliability of language model systems. This reliability is crucial for critical tasks such as fine-tuning and question answering, where trustworthiness and accuracy are paramount.

Consensus in Command Execution: The use of BGP ensures that the majority of loyal LLMs and micro-LLMs reach consensus on commands and responses. This means that even if a subset of components behaves untrustworthy, the system as a whole can reliably execute commands like fine-tuning and question answering, mitigating the impact of rogue or faulty elements.

Efficient Message Passing: The specialized GPU buses (e.g., NVLink or Infiniband) employed for message passing among LLMs and micro-LLMs optimize the communication process. This results in efficient data exchange, reducing latency, and enabling faster decision-making and execution.

Error Correction: In the context of question answering, where token width limitations or prompt injection can lead to issues, the approach ensures that loyal micro-LLMs can correct and override the responses provided by untrustworthy or improperly configured micro-LLMs. This leads to higher quality answers and improved overall system performance.

Scalability: The approach is scalable, allowing for the inclusion of additional LLMs and micro-LLMs as needed. As the system grows, it maintains its reliability and trustworthiness, even when the number of components increases.

Resilience to Faults: The BGP-based approach inherently builds resilience into the system. It can handle faults, disruptions, or anomalies gracefully, ensuring that mission-critical tasks can proceed uninterrupted.

Versatility: While the primary focus is on fine-tuning and question answering, the approach's versatility allows for its application in various scenarios where consensus and reliability among distributed components are essential.

The described embodiments of a multi-LLM, API, KG gateway presents a novel approach to managing and utilizing large language models, offering enhanced integration, dynamic model selection, scalability, security, automation, user-friendliness, and interoperability.

While example embodiments have been particularly shown and described, it will be understood by those skilled in the art that various changes in form and details may be made therein without departing from the scope of the embodiments encompassed by the appended claims.

What is claimed is:

1. A dynamic application programming interface (API) discovery system for conversational interfaces, comprising:
a processor; and
a memory with computer code instructions stored thereon, the memory operatively coupled to the processor such that, when executed by the processor, the computer code instructions cause the API discovery system to:
generate one or more prompts configured to advise a user of one or more permitted topics about which the user can have a conversation;
receive a conversation request from the user;
select one or more relevant application programming interfaces (APIs) based on (i) the conversation request provided by the user and (ii) an assigned guidance policy;
determine a semantic alignment score that measures relevance of the conversation with respect to a selected API; and
compare the semantic alignment score with a semantic alignment threshold and determine that the selected API is relevant to the conversation if the semantic alignment score is greater than or equal to the semantic alignment threshold.

2. The system of claim 1, wherein the alignment score is used to determine if conversation text associated with the conversation request aligns with one or more knowledge graphs.

3. The system of claim 2, wherein the one or more knowledge graphs comprises one or more of a taxonomy, an ontology, and associative properties of the taxonomy and the ontology.

4. The system of claim 1, wherein the system uses one or both of (a) an API from a static list of APIs and (b) an API associated with a knowledge graph.

5. The system of claim 4, wherein an administrator assigns a preference for strong reliance on an API from the static API list when the semantic alignment score exceeds a strong similarity threshold, and a deference to the knowledge graph or a large language model (LLM) for validation when no match occurs with the API list.

6. The system of claim 5, wherein the computer code instructions further cause the API discovery system to iteratively prompt the user for one or more API field values.

7. The system of claim 6, wherein the computer code instructions further cause the API discovery system to determine sufficiency an API field value from the user with respect to one or more of (a) permitted topics, (b) the knowledge graph, and (c) the LLM.

8. The system of claim 6, wherein the computer code instructions further cause the API discovery system to invoke the API after one or more API fields have been entered.

9. The system of claim 8, wherein the computer code instructions further cause the API discovery system to receive one or more API responses in response to invocation of the API.

10. The system of claim 9, wherein the computer code instructions further cause the API discovery system to transform the one or more API responses into human readable formats using at least one template associated with the API.

11. A method of implementing a dynamic application programming interface (API) discovery system for conversational interfaces, comprising:
generating one or more prompts configured to advise a user of one or more permitted topics about which the user can have a conversation;
receiving a conversation request from the user;
selecting one or more relevant application programming interfaces (APIs) based on (i) the conversation request provided by the user and (ii) an assigned guidance policy;
determining a semantic alignment score that measures relevance of the conversation with respect to a selected API; and
comparing the semantic alignment score with a semantic alignment threshold and determine that the selected API is relevant to the conversation if the semantic alignment score is greater than or equal to the semantic alignment threshold.

12. The method of claim 11, further using the alignment score to determine if conversation text associated with the conversation request aligns with one or more knowledge graphs.

13. The method of claim 11, further using one or both of (a) an API from a static list of APIs and (b) an API associated with a knowledge graph.

14. The method of claim 13, wherein an administrator assigns a preference for strong reliance on an API from the static API list when the semantic alignment score exceeds a strong similarity threshold, and a deference to the knowledge graph or a large language model (LLM) for validation when no match occurs with the API list.

15. The method of claim 14, wherein the computer code instructions further cause the API discovery system to iteratively prompt the user for one or more API field values.

16. The method of claim 15, further causing the API discovery system to determine sufficiency an API field value from the user with respect to one or more of (a) permitted topics, (b) the knowledge graph, and (c) the LLM.

17. The method of claim 15, further causing the API discovery system to invoke the API after one or more API fields have been entered.

18. The method of claim 17, further causing the API discovery system to receive one or more API responses in response to invocation of the API.

19. The method of claim 18, further causing the API discovery system to transform the one or more API responses into human readable formats using at least one template associated with the API.

20. The method of claim 18, further causing the API discovery system to use the conversation request from the user and the one or more API responses make one or more additional APIs relevant to the conversation.
